(19) United States
(12) Patent Application Publication
(10) Pub. No.: US 2011/0086197 A1
(43) Pub. Date: Apr. 14, 2011

(54) Decoration stone array board

(75) Inventor: Jin Ho Kim, Seoul (KR)

(73) Assignee: Kosam Co., Ltd.

(21) Appl. No.: 12/587,632

(22) Filed: Oct. 8, 2009

(51) Int. Cl. B32B 3/02

(52) U.S. Cl. 428/81

(57) ABSTRACT

A decoration stone array board is disclosed, in which a user can select a desired motive design and can array decoration stones thereon. The decoration stone array board comprises a mounting member which is formed in a plate shape and has a mounting hole for mounting a decoration stone and has a guide wall formed along an edge portion, and a support member which is attached to a lower surface of the mounting member.

### TECHNICAL FIELD

The present invention relates to a decoration stone array board, and in particular to a decoration stone array board in which a user can freely select a desired motive design or a desired pattern and can easily array decoration stones thereon.

### BACKGROUND ART

A decoration stone represents a small size thing, which is generally formed of precious metals, crystal, glass or plastic materials.

The decoration stone is a little expensive and is used as an ornamental or for collection, but in the present invention it represents a certain cheap material such as acryl or glass generally used for decorating an outer surface of clothes or bag.

The decoration stone used for decorating clothes or something has a plurality of reflection sides each being equipped with a thermally melting adhesive.

The decoration stones are arranged on a surface of clothes, and the upper sides of the decoration stones are heated and pressurized, and the thermally melting adhesive attached on the bottom sides of the same are melted and attached to clothes, as they are hardened.

Some of people call the decoration stones a hot-fix because the decoration stones have the above characteristics during process. More strictly speaking, the method for attaching decoration stones on clothes or something might be preferably called as a hot-fix.

Namely, the hot-fix represents a process that a plurality of decoration stones are arranged on a surface of a certain thing such as clothes and are melted and attached in the above-described manner as they are hardened.

As another method, a plurality of decoration stones are previously connected and commercially sold in a module form. The above decoration stones are generally called spangle.

In terms of hot-fix, it is needed to arrange each decoration stone one by one on an outer surface of clothes, and the arranged decoration stones are heated and pressurized. However, since many of decoration stones are formed of small size particles, it is really hard to arrange such small size decoration stones on a surface of clothes to be decorated.

Even when the decoration stones are arranged in place, they might be easily disarranged and moved during the heating and pressurizing process, so it is not easy to form a desired motive design using decoration stones.

So, ordinary users should commercially purchase the clothes previously decorated with decoration stones through a hot-fix process by a professional manufacturer.

However, in a conventional hot-fix work, a user should arrange each hot-fix one by one on an outer surface of a clothes or something, which leads to a lot of hard work.

Since the hot-fix is manufactured in various sizes, when they are formed in smaller sizes, it is harder to arrange a plurality of decoration stones on an outer surface of clothes or something.

Since the arranged hot-fixes might be disarranged and moved in the course of heating and pressurizing, an undesired pattern or design might be attached on an outer surface of a clothes. In this case, the hot-fix and decorated clothes cannot be used.

For the above reasons, many of users purchase the clothes previously decorated with hot-fixes by a big professional manufacturer. Since the manufacturers do hot-fix works using very limited motive designs or patterns, most of users, who want to decorate clothes in various patterns or motive designs, cannot be satisfied in the conventional art.

### DISCLOSURE OF THE INVENTION

Accordingly, it is an object of the present invention to provide a decoration stone array board which overcomes the problems encountered in the conventional art.

It is another object of the present invention to provide a decoration stone array board in which a user can select a desired motive design or pattern, and it is possible to do a hot-fix work in a desired portion of a clothes or something.

To achieve the above objects, there is provided a decoration stone array board which comprises a mounting member which is formed in a plate shape and has a mounting hole for mounting a decoration stone and has a guide wall formed along an edge portion; and a support member which is attached to a lower surface of the mounting member.

### EFFECTS

In the present invention, since a certain user can freely select a desired mounting member with various designs or patterns and can attach it to a mounting plate, so a user can easily array decoration stones in a desired design or pattern.

Since a guide wall is formed along an edge portion of a mounting plate, even when a hot-fix work is performed while the decoration stones are being randomly scattered on an upper surface of a mounting plate, the decoration stones are not disarranged and escaped to the outside of the mounting plate in the course of work, so they can be uniformly arranged after work.

In addition, the remaining decoration stones after the decoration stones are arranged and mounted into the mounting holes of the mounting member can be easily gathered and discharged through a discharge hole formed in one side of the guide wall, so an arranging work can be fast finished.

In the arranged decoration stone according to the present invention, it is possible to attach decoration stones in a desired portion of clothes in a desired design or a desired pattern using a transparent sheet or the like.

### BRIEF DESCRIPTION OF THE DRAWINGS

The present invention will become better understood with reference to the accompanying drawings which are given only by way of illustration and thus are not imitative of the present invention, wherein;

FIG. 1 is a perspective view illustrating a decoration stone array board according to an embodiment of the present invention;

FIG. 2 is a cross sectional view illustrating a decoration stone array board of FIG. 1;

FIG. 3 is a cross sectional view illustrating a state that a decoration stone is mounted in a mounting hole of a decoration stone array board of FIG. 1;

FIG. 4 is a perspective view illustrating a decoration stone array board according to another embodiment of the present invention;

FIG. 5 is a cross sectional view illustrating a decoration stone array board of FIG. 4; and

FIGS. 6a through 6d are views illustrating the use states of a decoration stone array board of FIG. 4.

### MODES FOR CARRYING OUT THE INVENTION

The preferred embodiments of the present invention will be described with reference to the accompanying drawings.

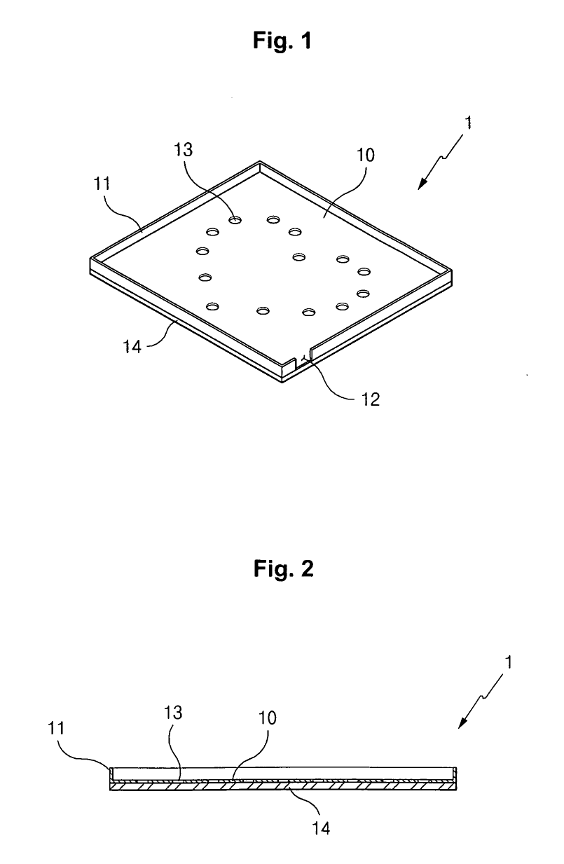

As shown in FIGS. 1 through 3, the decoration stone array board 1 according to an embodiment of the present invention comprises a mounting member 10 formed in a plate shape and having a guide wall 11 formed along an edge portion with a mounting hole 13 being formed for mounting decoration stones 2, and a support member which is attached to a lower surface of the mounting member 10.

In addition, a discharge hole 12 is formed in one side of the guide wall 11 for discharging the decoration stones 2 placed on an upper surface of the mounting member 10.

As shown in FIGS. 1 and 2, the mounting member 10 is formed in a plate shape for stably mounting decoration stones and is equipped with at least one mounting hole 13.

When a plurality of mounting holes are formed, the mounting holes 13 are formed in a certain pattern in a certain portion of the mounting member 10, and the patterns might be formed in various shapes, and the diameters or sizes of the pattern might be different.

The mounting holes 13 are formed in a certain image, a letter, a pattern or something, which looks good.

The support member 14 is attached to a lower surface of the mounting member 10 by means of which the mounting hole 13 is formed in such a manner that the upper surface of the support member 14 functions as a bottom of the mounting hole 13.

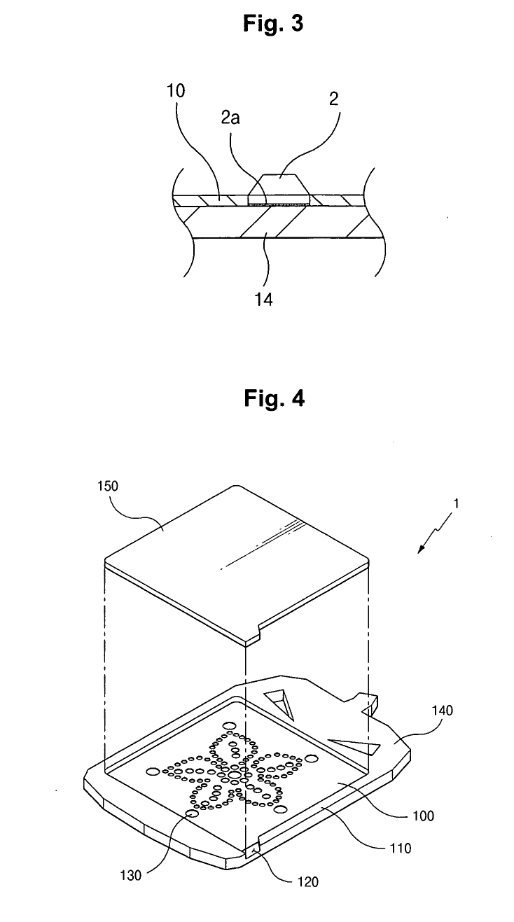

As shown in FIG. 3, a decoration stone 2 having a certain size corresponding to the size of the mounting hole is mounted into the mounting hole 13 in a state that the support member 14 is attached to the lower surface of the mounting member.

Since the upper surface of the support member 14 is attached to the whole portions of the lower surfaces of the mounting member 10, the decoration stone 2 is reliably mounted into the mounting hole 13 without inserting into the lower surface of the mounting member 10 around the neighboring mounting hole 13.

In the embodiment of the present invention, it is characterized that the support member 14 is attached, but it is not limited thereto. Namely, only a mounting member 10 having a mounting hole 13 or a mounting groove (not shown) might be provided in a state that a support member is not provided.

Since the decoration stone 2 is mounted into a corresponding portion of the mounting hole 13, it is possible to arrange the decoration stones in a desired motive design or pattern with the helps of the mounting holes 13 of the mounting member 10.

The decoration stones 2 might be randomly scattered around the mounting member 10 in the course of arranging the decoration stones 2 in the above manner. Gathering and cleaning the scattered decoration stones 2 while picking up each decoration stone, make a worker feel hard and inconvenient, which even needs more work time.

Therefore, in the embodiment of the present invention, the edge portion of the mounting member 10 is equipped with a guide wall 11 which might be formed by bending an edge portion of the mounting member or which might be formed as a separate member is attached to an edge portion of the same.

With the helps of the guide wall 11, it is possible to easily arrange decoration stones 2 on the upper surface of the mounting member 10 without scattering the decoration stones 2 toward the outside of the mounting member 10.

In the embodiment of the present invention, a discharge groove 12 is preferably formed in one side of the guide wall 11.

The other decoration stones remaining after arranging the decoration stones and other things can be easily gathered and discharged through the discharge groove 12 when gathering and storing the remaining decoration stones in a certain container after all the mounting holes 13 are filled with the decoration stones 2, so faster and easier gathering and cleaning works are possible.

At this time, the inlet opening of the discharge groove is preferably larger than the outlet opening for easier discharge of the decoration stones, the operation of which can be more understood with the helps of another embodiment of the present invention as shown in FIG. 4 which will be described later.

The mounting member 10 and the support member 14 are preferably made of paper or the like which is not expensive. However, the materials of the same are not limited thereto. It is obvious that various materials can be used for the same purpose.

A plurality of mounting members 10 having various designs or patterns formed by the mounting holes 13 might be manufactured and sold by a manufacturer. In this case, a user can just select a desired one among the various mounting members 10.

A user can manufacture the mounting holes 13 to have a desired motive design.

The procedure for attaching the decoration stones 2 on clothes or the like by using a decoration stone array 1 according to an embodiment of the present invention is not different from that of another embodiment of the present invention, so the procedure will be described later in another embodiment description.

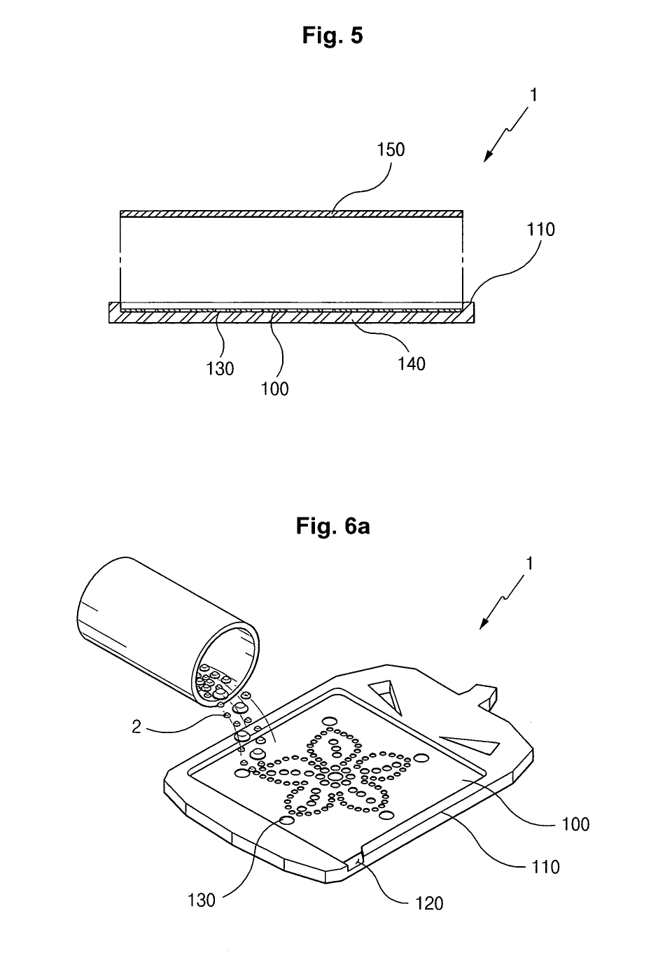

As shown in FIGS. 4 through 6, the decoration stone array board 1 according to another embodiment of the present invention comprises a mounting plate 140 formed in a plate shape and having a guide wall 110 along an edge portion, and a mounting member 100 which is detachably attached to an upper surface of the mounting plate 140 and has mounting holes 130 for mounting the decoration stones 2.

A discharge groove 120 is formed in one side of the guide wall for discharging the decoration stones 2 placed on an upper surface of the mounting member 100.

In the embodiment of the present invention, a cover plate 150 is further provided along with the above-described features. The cover plate 150 is formed in a plate shape matching with the shape of an opening for thereby substantially covering the opening formed on the upper side of the mounting plate 140 along an inner side surface of the guide wall.

As shown in FIGS. 3 and 4, a flat plate shaped mounting plate 140 is provided, and a guide wall 110 is formed along an edge portion of the mounting plate 140 which has the same function as that of the earlier embodiment of the present invention.

A discharge groove 120 is formed in one side of the guide wall 110 and has the same function as the earlier embodiment of the present invention.

As not shown in the drawings, the mounting member 100 is equipped with an adhering surface on its bottom surface for a detachable operation from a certain thing. The mounting member 100 is detachably attached to an upper surface of the mounting plate 140.

The mounting member 100 is equipped with at least one mounting hole 130, and the mounting holes 130 are closely attached to an upper surface of the mounting plate 140 by means of which a mounting groove is formed.

The shape and function of the mounting hole 130 and the material of the mounting member 100 are the same as the earlier embodiment of the present invention. So, the descriptions of the same will be omitted.

The mounting member 100 might be formed of a plurality of mounting members 100 by a manufacturer for thereby forming various designs and patterns with the helps of the mounting holes 130, and a user can freely select and purchase a mounting member having a desired design or pattern.

According to an embodiment of the present invention, it is possible to manufacture the mounting member 100 for forming the mounting holes 130 having a desired motive design.

An opening is formed on an upper side of the mounting plate 140 along an inner side surface of the guide wall 110, and a flat shaped cover plate 150 might be further provided matching with the shape of the opening for thereby substantially covering the opening.

When the opening is covered by the cover plate 150, the mounting plate 140, the mounting member 100 and the cover plate 150 are engaged with one another with no part being protruded to the outside, so a flat plate shaped structure is obtained. The user can easily store and manage the decoration stone array board 1.

The operation for attaching the decoration stones 2 to an outer side of clothes or something by using the decoration stone array board 1 according to another embodiment of the present invention will be described.

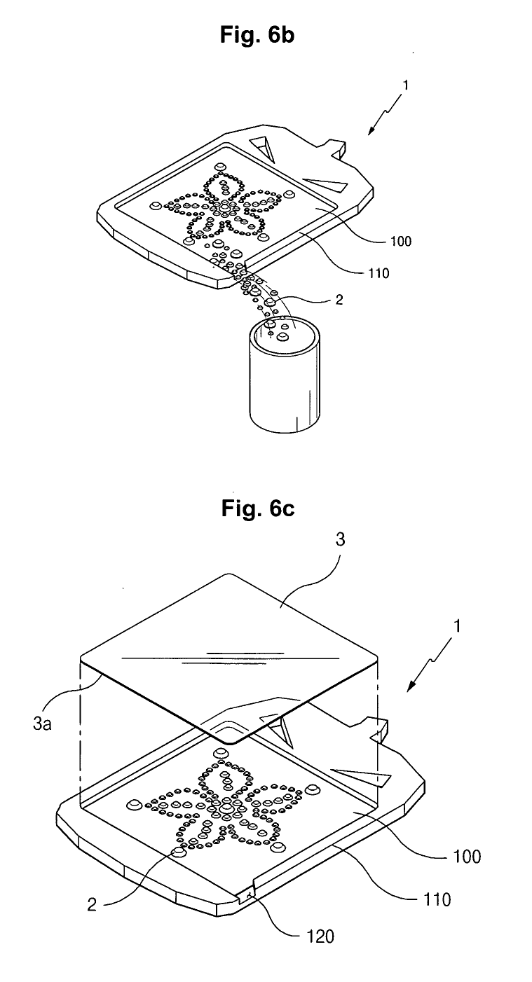

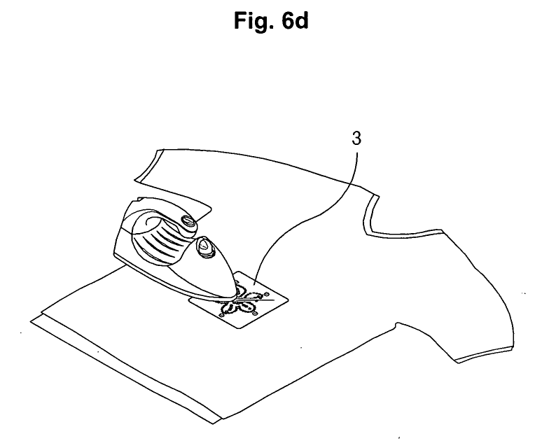

FIGS. 6A through 6D are views illustrating a use state of the present invention.

A user prepares a mounting member 100 having mounting holes 130 formed in a certain motive design or pattern that he wants.

As not shown in the drawings, the mounting member 100 is equipped with an adhering surface on its bottom surface, so it is temporarily attached to an upper surface of the mounting plate 140 (this feature is not provided in the earlier embodiment of the present invention).

The mounting holes 130 formed in the mounting member 100 become the mounting grooves as the lower side of the mounting member 100 is closely attached to the upper side of the mounting plate 140, so the decoration stones 2 are arranged in the mounting groove (In the earlier embodiment of the present invention, such construction is obtained as the support member 14 is attached to a lower surface of the mounting member 10).

The decoration stones 2 are commercially sold with the decoration stones 2 being classified by shapes, colors and sizes and being stored in a certain container. So, the user can purchase a desired one.

It is possible for a user to pick up the decoration stone 2 from the container one by one and to arrange the decoration stone on a corresponding portion of the mounting hole 130, but in the present invention since a guide wall 110 is formed along an edge portion of the mounting plate 140 (which corresponds to the mounting member 10 in the earlier embodiment of the present invention), a certain number of decoration stones are randomly prepared on the upper surface of the mounting member 100 at one time, and the decoration stones are arranged into the portions of the mounting holes 130.

Since the mounting holes 130 can be formed in various sizes matching with the sizes of the decoration stones 2, when the arranging work of the decoration stones 2 with respect to one size is finished, the remaining decoration stones 2 with another size are discharged through the discharge groove 120 and are stored in the container.

When working with the decoration stone with another size, such decoration stones 2 can be easily arranged in the corresponding portions of the mounting holes 130 with the helps of the above methods.

When arranging work is finished, a transparent sheet 3 with an adhering surface 3a on its lower surface for a temporal attachment is attached on an upper surface of the mounting member 100 with a certain level of pressure.

The above transparent sheets are commercially sold, so a user can easily purchase.

When the transparent sheet 3 is detached from the upper surface of the mounting member 100, the upper surfaces of the decoration stones 2 are temporarily attached to the lower surface of the transparent sheet 3, and the decoration stones are detached from the mounting member 100 along with the transparent sheet 3.

A user attaches the transparent sheet 3 to a certain portion of the outer surface of clothes or something, and covers a cloth such as towel or the like on the same, and heats the transparent sheet 3 while applying a certain level of pressure by using an iron or something.

Since the decoration stones 2 are equipped with the thermal melting adhesive 2a on their lower surfaces, the adhesive melts in the course of heating and pressurizing process, so the decoration stones are fixedly attached to the outer surface of clothes as the melted portions are hardened.

Thereafter, the transparent sheet 3 is removed for thereby manufacturing a clothes equipped with the decoration stones 2 attached thereon in a desired design or pattern.

The decoration stone array board according to further another embodiment of the present invention has the same construction and function as the above-described another embodiment of the present invention.

The decoration stone array board according to further another embodiment of the present invention is not shown in the drawings, and the same construction and elements as the earlier embodiments of the present invention will be given the same reference numerals. So, the further another embodiment of the present invention can be referred to the drawings of the earlier embodiments of the present invention.

The decoration stone array board 1 according to further another embodiment of the present invention comprises a mounting plate 140 which is formed in a plate shape and has a guide wall 110 formed along an edge portion, and a mounting member 100 which has a mounting hole 130 for mounting a decoration stone with a support member 14 being attached to a lower surface of the mounting member 100, with the mounting member 100 being placed on an upper surface of the mounting plate 140.

In addition, a discharge groove 120 is formed in one side of the guide wall 110 for discharging the decoration stones placed on the upper surface of the mounting member 100.

A cover plate 150 formed in a plate shape is further provided for covering an opening formed in an upper side of the mounting plate formed by means of the guide wall 110.

In the further another embodiment of the present invention, the support member 14 is attached to a lower surface of the mounting member 100 as compared to the earlier embodiments of the present invention.

The mounting member 100 with a support member 14 being attached to a lower surface of the mounting member 100 is detachably attached to an upper surface of the mounting plate 140 by providing an adhering surface to a lower surface of the support member 14, provided that it is placed on an upper surface of the mounting plate in the further another embodiment of the present invention.

The operation of the further another embodiment of the present invention is the same as the earlier embodiments of the present invention. So, the description of the operation will be omitted.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A decoration stone array board, comprising:
a mounting member which is formed in a plate shape and has a mounting hole for mounting a decoration stone and has a guide wall formed along an edge portion; and
a support member which is attached to a lower surface of the mounting member.

2. The decoration stone array board of claim 1, wherein a discharge groove is formed in one side of the guide wall for discharging the decoration stones placed on an upper surface of the mounting member.

3. A decoration stone array board, comprising:
a mounting plate which is formed in a plate shape and has a guide wall formed along an edge portion; and
a mounting member which is detachably attached to an upper surface of the mounting plate and has a mounting hole for mounting a decoration stone.

4. The decoration stone array board of claim 3, wherein a discharge groove is formed in one side of the guide wall for discharging the decoration stones placed on an upper surface of the mounting member.

5. The decoration stone array board of claim 4, further comprising a cover plate which is formed in a plate shape for thereby covering an opening formed in an upper side of the mounting plate formed by means of the guide wall.

6. The decoration stone array board of claim 3, further comprising a cover plate which is formed in a plate shape for thereby covering an opening formed in an upper side of the mounting plate formed by means of the guide wall.

7. A decoration stone array board, comprising:
a mounting plate which is formed in a plate shape and has a guide wall along an edge portion; and
a mounting member which has a mounting hole for mounting a decoration stone with a support member being attached to a lower surface of the same and has a mounting member placed on an upper surface of the mounting plate.

8. The decoration stone array board of claim 7, wherein a discharge grooves is formed in one side of the guide wall for discharging the decoration stones placed on an upper surface of the mounting member.

9. The decoration stone array board of claim 8, further comprising a cover plate which is formed in a plate shape for thereby covering an opening formed in an upper side of the mounting plate formed by means of the guide wall.

10. The decoration stone array board of claim 7, further comprising a cover plate which is formed in a plate shape for thereby covering an opening formed in an upper side of the mounting plate formed by means of the guide wall.
